(19) United States
(12) Patent Application Publication
(10) Pub. No.: US 2021/0246008 A1
(43) Pub. Date: Aug. 12, 2021

(54) WHEEL-OPERATED TREE CLIMBING APPARATUS AND METHOD

(71) Applicant: Gana Kiritharan, Scarborough (CA)

(72) Inventor: Gana Kiritharan, Scarborough (CA)

(21) Appl. No.: 17/163,351

(22) Filed: Jan. 30, 2021

Related U.S. Application Data
(60) Provisional application No. 62/975,281, filed on Feb. 12, 2020.

(51) Int. Cl. B66F 11/04; A63B 27/00

(52) U.S. Cl. CPC B66F 11/04; A63B 27/00

(57) ABSTRACT

The present specification relates generally to a tree climbing apparatus, and specifically to a wheel-operated tree climbing apparatus. The tree climbing apparatus includes a frame, including a first frame end and a second frame end, that is configured to receive a tree trunk, as well as a pair of rollers, including a first roller and a second roller, the first roller being securable to the frame, proximate to the first frame end and the second roller secured to the frame, proximate to the second frame end. The wheel-operated tree climbing apparatus also includes a pedalling system, whereby the pedalling system engages with and rotates at least one rollers of the pair of rollers and a motor, whereby the motor engages with and rotates at least one rollers of the pair of rollers. A related method of climbing a tree using a wheel-operated tree climbing apparatus is also described.

### FIELD OF THE INVENTION

The present specification relates generally to a tree climbing apparatus, and specifically to an apparatus and method for climbing trees using a wheel-operated apparatus powered by pedaling or a motor.

### BACKGROUND OF THE INVENTION

In most parts of the world, tree climbing is a skilled manual job. It requires physical strength and endurance, as well as mastery of the technique, as climbers are often required to perform farming operations at 10 to 15 meters above ground. Accordingly, this type of work can be very dangerous, and loss of a climber's grip can result in a serious fall.

Further, manual climbing of a tree can take upward of 20 minutes in order to reach the crown, where most farming occurs. Given the time required to climb a tree, this can be an inefficient use of a farmer's time. Further, it can become very difficult to perform tasks associated with farming, such as pruning and harvesting, without a secure attachment to the tree.

While there are a number of mechanical devices that can assist climbers, such as harnesses and crampon-like footwear, they often still require a great deal of physical ability and expertise. Further, existing motorized assistive climbing technologies are often bulky, expensive and unable to handle the weight requirements of a climber and his or her tools.

Accordingly, there remains a need for improvements in the art.

### SUMMARY OF THE INVENTION

In an embodiment of the present invention, there is provided a tree climbing apparatus, comprising a frame, including a first frame end and a second frame end, the first frame end configured to receive a tree trunk; a pair of rollers, including a first roller and a second roller, the first roller being securable to the frame, proximate to the first frame end and the second roller secured to the frame, proximate to the second frame end; a pedalling system, whereby the pedalling system engages with and rotates at least one rollers of the pair of rollers; and a motor, whereby the motor engages with and rotates at least one rollers of the pair of rollers.

In an embodiment of the present invention, there is provided a method of climbing a tree, comprising receiving a tree trunk between two arms of a first frame end; securing a first roller on the two arms proximate to the first frame end, such that the first roller and a second roller abut the tree trunk and rotating at least one of the first and second rollers in a direction such that a top portion of the at least one rollers rotates towards the tree trunk.

Other aspects and features according to the present application will become apparent to those ordinarily skilled in the art upon review of the following description of embodiments of the invention in conjunction with the accompanying figures.

### BRIEF DESCRIPTION OF THE DRAWINGS

The principles of the invention may better be understood with reference to the accompanying figures provided by way of illustration of an exemplary embodiment, or embodiments, incorporating principles and aspects of the present invention, and in which:

FIG. 1 is a side view of a wheel-operated tree climbing apparatus, according to an embodiment;

FIG. 2 is a top, plan view of the tree climbing apparatus of FIG. 1, secured about a tree trunk;

FIG. 3 is a transportation vehicle for a wheel-operated tree climbing apparatus, according to an embodiment; and

FIG. 4 is a side view of the tree climbing apparatus of FIG. 1, secured about a tree trunk.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order more clearly to depict certain features of the invention.

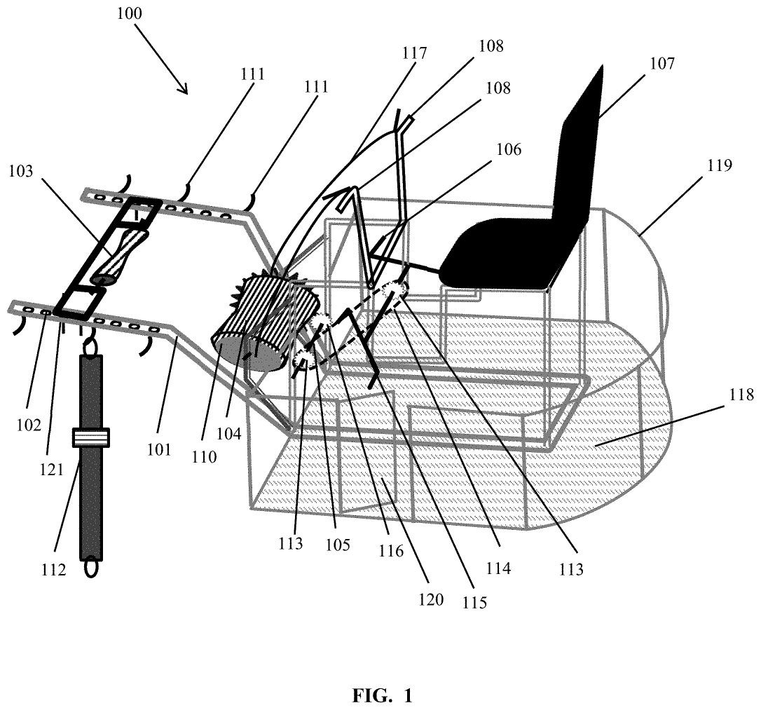

According to an embodiment as shown in FIGS. 1, 2 and 4, a tree climbing apparatus 100 is configured to provide a motorized, wheel-operated means of climbing a tree. Accordingly, tree climbing apparatus 100 may be utilized by users who do not have the required physical strength and endurance or knowledge and mastery of the required technique to manually climb a tree. Further, tree climbing apparatus 100 may provide traditional tree climbing farmers a safer alternative to manually climbing a tree, as it eliminates the reliance on a user's physical ability and skill and, rather, provides a mechanical means of transportation that includes a seat, safety mechanisms, such as locking and braking systems. Tree climbing apparatus 100 may also decrease the time and effort needed to climb a tree and may also allow a user to easily stow tools, which can be heavy or cumbersome to carry.

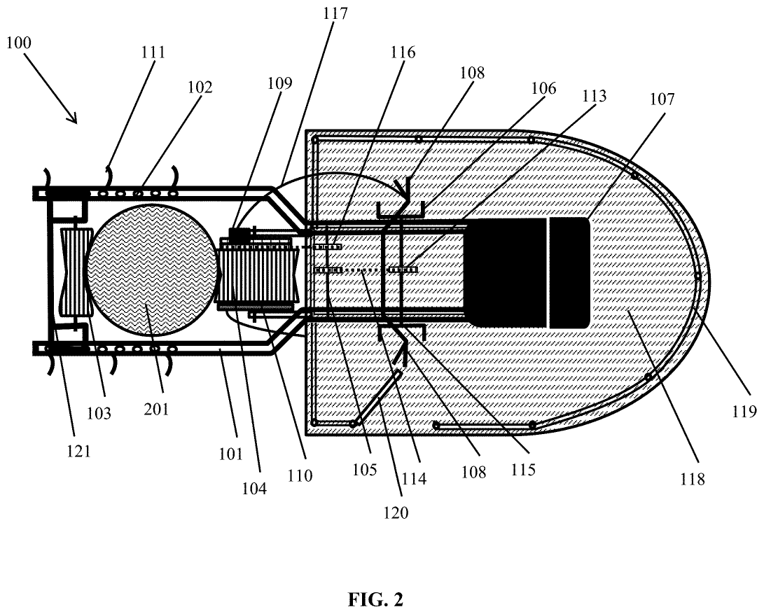

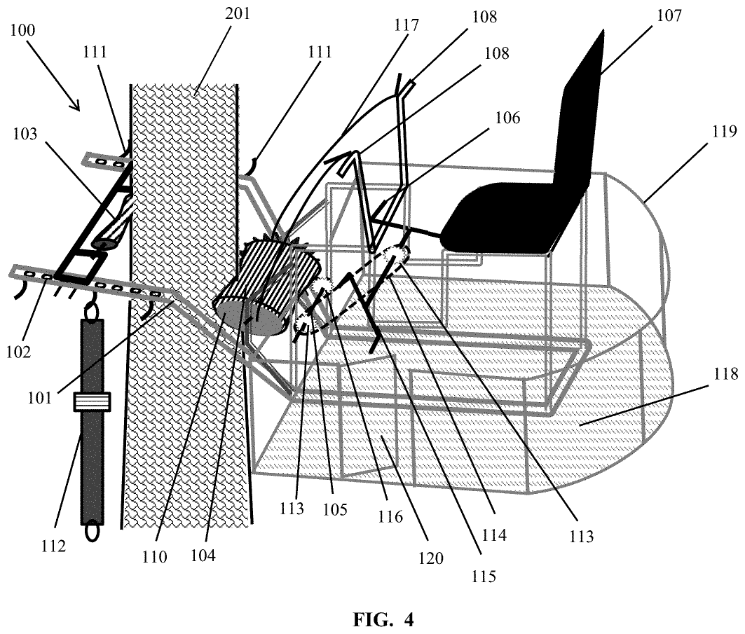

Tree climbing apparatus 100 includes a frame 101. Frame 101 may be formed from a single piece of metal into a U-shaped design, as shown in FIG. 2, comprising an open, first frame end and a closed, second frame end. From a side view, frame 101 may be Z-shaped, as shown in FIGS. 1 and 4, such that the first frame end is positioned vertically above the second frame end, when tree climbing apparatus 100 is in an upright position. The first frame end is open, in order to receive a tree trunk 201. The second frame end is located opposite the open, first frame end and is generally closed. Proximate the second frame end is a seat 107, on which a user may sit, and handles 108, from which a user may control tree climbing apparatus 100 (e.g., by pedalling, motor or engine). According to an embodiment, seat 107 may be configured to rotate 360 degrees about its Y-axis. The ability to rotate seat 107 may enable a user to obtain a complete view of the user's surroundings while using tree climbing apparatus 100. Rotation of seat 107 may also provide additional advantages to particular users, for example, hunting enthusiasts, who may benefit from an unobstructed view of targets.

Tree climbing apparatus 100 and, in particular, frame 101, may be constructed from materials which provide sufficient mechanical strength and rigidity to transport a human up a tree trunk. According to an embodiment, tree climbing apparatus 100 may be constructed of plastic, wood, aluminum, steel or composites or a combination of suitable materials. Manufacturing costs and desired lifespan may be considerations in informing the choice of materials and construction technique and design choices of tree climbing apparatus 100.

Tree climbing apparatus 100 further includes a pair of rollers, a first roller 103 and a second roller 104. First roller 103 is securable proximate to the first frame end and second roller 104 is secured proximate to the second frame end. First roller 103 may be adjustably securable on frame 101 proximate to the first frame end by securing first roller 103 within holes 102. This adjustable securing mechanism allows tree climbing apparatus 100 to accommodate tree trunks of various sizes, which is discussed further below. Second roller 104 is generally larger than first roller 103 and is permanently affixed to frame 101. Both first roller 103 and second roller 104 may be formed about an axle and utilize bearings, to allow rollers 103 and 104 to freely rotate as tree climbing apparatus 100 climbs up and down a tree trunk. According to an embodiment, as shown in FIGS. 1, 2 and 4, rollers 103 and 104 may be substantially cylindrical with concave indentations to accept the curvatures of a tree trunk. According to a further embodiment, rollers 103 and 104 may be perfectly cylindrical. Rollers 103 and 104 may also include a tread, in order to further enhance grip of the rollers around a tree trunk. Further, as shown in FIGS. 1 and 4, first roller 103 is securable on frame 101, proximate the first frame end, vertically above that of the second roller 104, when tree climbing apparatus 100 is in an upright orientation.

Rollers 103 and 104 may be constructed from materials which provide sufficient mechanical strength and rigidity to grip a tree trunk. According to an embodiment, rollers 103 and 104 may be constructed of plastic, rubber or composites or a combination of suitable materials. Manufacturing costs and desired lifespan may be considerations in informing the choice of materials and construction technique and design choices of rollers 103 and 104.

Holes 102 are disposed on both arms of U-shaped frame 101 along the open, first frame end, such that when first roller 103 is secured between holes 102 on opposite sides of frame 101, first roller 103 is secured perpendicular to frame 101. According to an embodiment, holes 102 may be placed two inches apart along both arms of U-shaped frame 101. First roller 103 may be further secured within holes 102 by using additional fasteners, such as metal clips or other suitable fasteners known in the art, or by use of a metal frame, such as metal frame 121.

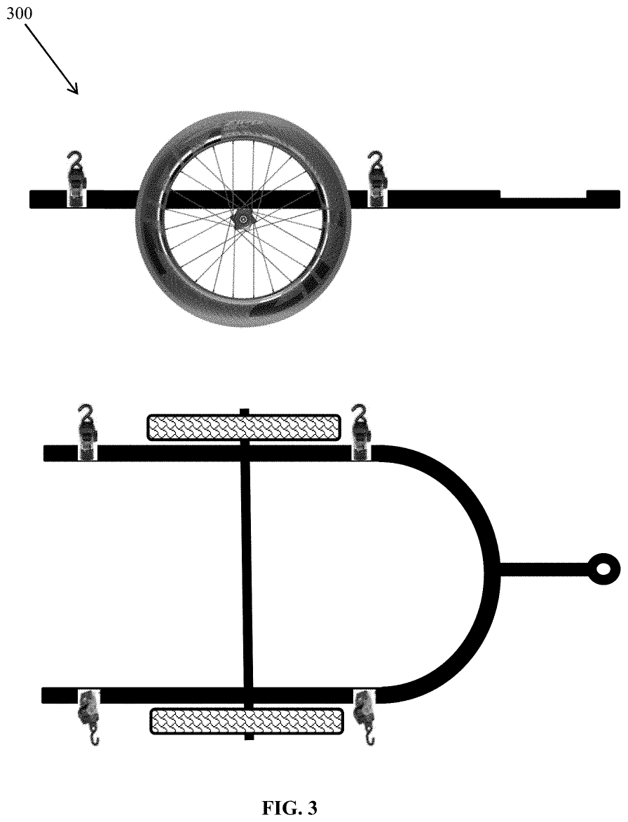

In order to use tree climbing apparatus 100 to climb a tree, tree climbing apparatus 100 should be positioned proximal to a tree trunk that is to be climbed. A tree climbing apparatus may include integrated wheels, for example, which would allow for the rolling of tree climbing apparatus into position. Alternatively, or in addition, a tree climbing apparatus may be used in conjunction with a transportation system 300, as shown in FIG. 3, in order to cart a tree climbing apparatus to a tree trunk from one location to another. Tree climbing apparatus transportation system 300 may contain one or more wheels, one or more fasteners, such as hooks and belts, and at least one hitch, in order to securely and easily move a tree climbing apparatus into position to climb a tree.

During positioning of tree climbing apparatus 100, the two arms of U-shaped frame 101, located at the first frame end, receive tree trunk 201 therebetween, such that tree trunk 201 is adjacent to and abuts second roller 104. To secure tree climbing apparatus 100 about tree trunk 201, first roller 103 is secured on the two arms of U-shaped frame 101 on the side of tree trunk 201 opposite second roller 104. First roller 103, like second roller 104, should be adjacent to and abut tree trunk 201. Further, the first frame end may be pushed towards the ground, so that first roller 103 can be secured to a set of holes 102 that are closest to tree trunk 201. After first roller 103 is secured, both rollers 103 and 104 should be sufficiently close to tree trunk 201, such that they are both tightly griping tree trunk 201. Further, applying a force (for example, a user's weight) proximate to the second frame end may cause the tree climbing apparatus 100 to tilt in a vertical direction and towards the tree trunk, applying an equal and opposite force against the tree trunk, causing first frame end and first roller 103 to further grip the tree trunk 201.

Once tree climbing apparatus 100 is situated as described above, tree climbing apparatus 100 is in position to climb tree trunk 201. This is accomplished by rotating rollers 103, 104 or both in a direction such that a top portion of rollers 103, 104 or both rotate towards tree trunk 201. According to an embodiment, as shown in FIGS. 1, 2 and 4, roller 104 is rotated by way of a pedaling system. The pedaling system comprises four pedals 106 and four arm cranks 115, as well as gears 113 and chain 114. According to a further embodiment, a pedaling system may be comprised of two pedals and two arm cranks, instead of four. Further, pedals 106 are offset at 90 degrees. A user may exert force on pedals 106, preferably by using one's legs and feet to step from one pedal to next one and by continuously exerting an equal amount of pressure on each pedal, which in turn causes chain 114 to engage with gears 113 and rotate shaft 105. Shaft 105 is affixed to frame 101 and may contain one or more toothed wheels, as well as bearings to ensure proper rotation of shaft 105. As shaft 105 is rotated, toothed wheel 116 engages with ridges on second roller 104, causing second roller 104 to rotate. According to an embodiment, toothed wheel 116 may indirectly rotate second roller 104 by a chain. According to a further embodiment, a pedaling system may engage with and rotate first roller 103, second roller 104 or both. Any number and size of gears and toothed wheels may be used to further effect the power, speed and direction exerted on rollers 103, 104 or both.

According to a further embodiment, a gasoline engine or electric motor may be used in addition to or in place of the pedaling system, in order to rotate shaft 105, toothed wheel 116, first roller 103, second roller 104 or any combination of the foregoing.

Tree climbing apparatus 100 also includes several security mechanisms, such as a locking system. As shown in FIGS. 1, 2 and 4, the locking system is comprised of a ratchet lock 109, a cable 117 and a lever (not shown). Ratchet lock 109 is attached to frame 101 and at least one side of second roller 104 which, when engaged, prevents secondary roller 104 from rolling in a direction such that a top portion of secondary roller 104 rotates away from tree trunk 201. In other words, the locking system may prevent tree climbing apparatus 100 form slipping from an achieved height when engaged and, when released, allows tree climbing apparatus 100 to descend down a tree trunk. Cable 117 is in connection with ratchet lock 109 and controls the engagement and release of ratchet lock 109. Ratchet lock 109 is engaged and released by, for example, toggling a lever. A lever, or any similar control mechanism, may be placed on either or both handles 108 in order to engage and release ratchet lock 109. In a further embodiment, a locking system may be provided by way of a combination of other locking and releasing components and may also be used to prevent first roller 103, second roller 104, toothed wheel 116 or any combination of one or more of the foregoing from rotating in a direction that would cause tree climbing apparatus 100 from slipping from an achieved height.

Tree climbing apparatus 100 may also include a further security mechanism, brake system 110. Brake system 110 is comprised of at least one pad which, when engaged, exerts friction on at least one side of second roller 104, which controls the speed at which secondary roller 104 rotates and, if necessary, stops secondary roller 104 from rotating. As a result, brake system 110 may control the speed at which tree climbing apparatus 100 climbs and descends a tree trunk. The engagement and release of brake system 110 is controlled, for example, by a lever on one or both of handles 108. Brake system 110 may be provided by way of any known breaking mechanisms known in the art, such as spoon, duck, rim, disc, drum, coaster, drag or band brakes. According to an embodiment, a brake system may be used to control the speed at which and, if necessary, stop first roller 103, second roller 104, toothed wheel 116 or any combination of foregoing from rotating.

According to an embodiment, as shown in FIGS. 1 and 4, frame 101 further comprises hooks 111 that are attached to the top of both arms of U-shaped frame 101 proximate the open, first frame end. As a further locking mechanism, hooks 111 are suitable for fastening a belt 112 around a tree trunk and to each arm of U-shaped frame 101, in order to secure tree climbing apparatus at a desired height along a tree trunk.

According to an embodiment, as shown in FIGS. 1, 2 and 4, tree climbing apparatus 100 may also include a platform 118, a barrier 119 and a gate 120 to improve the functionality of and increase user safety while operating tree climbing apparatus 100. Platform 118 may provide additional space in which the user may walk while tree climbing apparatus 100 is suspended in the air, facilitating the performance of one or more tasks or activities. These tasks and activities may include, for example, pruning the tree or harvesting from the tree. Barrier 119 may provide greater security to the user during operation of the tree climbing apparatus 100 and in the course of performing these activities by reducing the likelihood of the user falling from seat 107 or platform 118 while tree climbing apparatus 100 is suspended in the air. According to an embodiment, barrier 119 may be a handrail. According to another embodiment, barrier 119 may be a cage structure affixed to platform 118 and fully enclosing seat 107 virtually eliminating the possibility of sustaining a fall from seat 107 or platform 118, while operating tree climbing apparatus 100. According to an embodiment, the cage structure may be comprised of one or more of metal frames, plexiglass and nets. Such structures may provide protection from the weather, insects and/or small animals. According to a further embodiment, the cage structure may have windows to maintain the visibility of the user's surroundings while operating tree climbing apparatus from inside barrier 119. Gate 120 may provide the user with easy entry to and exit from barrier 119, while preserving the safety benefits of barrier 119.

According to an embodiment, various toolboxes or other tool carrying devices may be attached to tree climbing apparatus 100, facilitating the carrying of one or more tools up the height of the tree to be employed by the user.

Various embodiments of the invention have been described in detail. Since changes in and or additions to the above-described best mode may be made without departing from the nature, spirit or scope of the invention, the invention is not to be limited to those details but only by the appended claims.

What is claimed is:

1. A tree climbing apparatus, comprising:
a frame, including a first frame end and a second frame end, the first frame end configured to receive a tree trunk;
a pair of rollers, including a first roller and a second roller, the first roller being securable to the frame, proximate to the first frame end and the second roller secured to the frame, proximate to the second frame end;
a pedalling system, whereby the pedalling system engages with and rotates at least one rollers of the pair of rollers; and
a motor, whereby the motor engages with and rotates at least one rollers of the pair of rollers.

2. The tree climbing apparatus of claim 1, wherein the motor is an electric-powered motor.

3. The tree climbing apparatus of claim 1, wherein the motor is a gas-powered engine.

4. The tree climbing apparatus of claim 1, further comprising a seat and a pair of handles affixed to the frame.

5. The tree climbing apparatus of claim 1, wherein the first roller is adjustably securable on the frame proximate to the first frame end.

6. The tree climbing apparatus of claim 1, wherein the pedalling system comprises four pedals and four arm cranks, each pedal and corresponding arm crank positioned 90 degree relative to each other.

7. The tree climbing apparatus of claim 1, wherein the first frame end includes hooks, configured to be suitable for fastening a belt around the tree trunk and to the frame proximate to the first frame end.

8. The tree climbing apparatus of claim 1, wherein the apparatus includes a braking system comprising at least one brake pad, whereby the brake pad frictionally engages with the at least one rollers to stop the at least one rollers from rotating.

9. The tree climbing apparatus of claim 1, wherein the apparatus includes a locking system comprising a ratchet lock, a cable and a lever, whereby the cable is connected to the ratchet lock and the lever and, when the lever is toggled, the cable engages with and applies the ratchet lock to at least one rollers of the pair of rollers and stops the at least one rollers from rotating in a direction such that a top portion of the at least one rollers rotates away from the tree trunk.

10. The tree climbing apparatus of claim 1, wherein the first roller is secured on the frame proximate to the first frame end at a position vertically above that of the second roller when the tree climbing apparatus is in an upright orientation.

11. Use of the tree climbing apparatus of claim 1 to climb trees.

12. A method of climbing a tree, comprising:
receiving a tree trunk between two arms of a first frame end;
securing a first roller on the two arms proximate to the first frame end, such that the first roller and a second roller abut the tree trunk;
applying a force proximate to a second frame end, whereby the first frame end and the first roller tilt in a vertical direction and apply an equal and opposite force against the tree trunk;
rotating at least one of the first and second rollers in a direction such that a top portion of the at least one rollers rotates towards the tree trunk.

13. The method of climbing a tree of claim 12, wherein a motor engages with and rotates at least one rollers of the first and second rollers.

14. The method of climbing a tree of claim 12, wherein a pedalling system engages with and rotates at least one rollers of the first and second rollers.

15. The method of climbing a tree of claim 12, wherein the first roller is adjustably securable along the frame proximate to the first frame end.

16. The method of climbing a tree of claim 13, wherein the pedalling system comprises four pedals and four arm cranks, each pedal and corresponding arm crank positioned 90 degree relative to each other.

17. The method of climbing a tree of claim 12, wherein the first frame end includes hooks, configured to be suitable for fastening a belt around the tree trunk and to the frame proximate to the first frame end.

18. The method of climbing a tree of claim 12, wherein at least one rollers of the first and second rollers is engaged with a braking system comprising at least one brake pad, whereby the brake pad frictionally engages with the at least one roller to stop the at least one roller from rotating.

19. The method of climbing a tree of claim 12, wherein at least one rollers of the first and second rollers is engaged with a locking system comprising a ratchet lock, a cable and a lever, whereby the cable is connected to the ratchet lock and the lever and, when the lever is toggled, the cable engages with and applies the ratchet lock to at least one rollers of the pair of rollers to stop the at least one rollers from rotating in a direction such that a top portion of the at least one rollers rotates away from the tree trunk.

20. The method of climbing a tree of claim 12, wherein the first roller is secured on the frame proximate to the first frame end at a vertically above that of the second roller when the tree climbing apparatus is in an upright orientation.
